(19) United States
(12) Patent Application Publication
(10) Pub. No.: US 2026/0217182 A1
(43) Pub. Date: Jul. 30, 2026

(54) UNIVERSAL VEHICLE STRAPPING SYSTEM

(71) Applicant: Curt Lillibridge, Everette, WA (US)

(72) Inventor: Curt Lillibridge, Everette, WA (US)

(21) Appl. No.: 19/457,479

(22) Filed: Jan. 23, 2026

Related U.S. Application Data
(60) Provisional application No. 63/749,124, filed on Jan. 24, 2025.

(51) Int. Cl. B60P 7/08

(52) U.S. Cl. CPC B60P 7/0838; B60P 7/0869

(57) ABSTRACT

Apparatus and associated methods relate to a vehicle strapping system with two or more straps, wherein each strap includes two or more strap channels and two or more opposing securing mechanisms configured such that the first securing mechanism operably couples to a first wheel well and the second securing mechanism operably couples to a second wheel well with at least one strap positioned over the front of a vehicle and at least one strap positioned over the rear of a vehicle. In an illustrative example, a strapping system may include two or more straps. At least one strap, for example, be positioned at the front of a vehicle. At least one opposing strap may, for example, be positioned at the rear of the vehicle. Each strap may, for example, include two or more securing mechanisms. Various embodiments may advantageously enable the strapping system to strap longitudinal material to vehicles.

### CROSS-REFERENCE TO RELATED APPLICATIONS

This application also claims the benefit of U.S. Provisional Application Ser. No. 63/749,124, titled “Vehicle Strapping System,” filed by Curt Lillibridge, on Jan. 24, 2025.

This application incorporates the entire contents of the foregoing application(s) herein by reference.

### TECHNICAL FIELD

Various embodiments relate generally to a vehicle strapping system.

### BACKGROUND

Vehicles play a vital role in modern travel, enabling people to explore distant destinations and connect with others across vast distances. From cars and motorcycles to buses and trains, these modes of transportation provide convenience, speed, and flexibility in daily commutes and long journeys alike. Whether for work, leisure, or exploration, vehicles are integral to the way we navigate and experience the world.

Straps are essential tools for securing objects to vehicles, ensuring safety and stability during transportation. Straps come in various forms each designed for specific applications. They often feature mechanisms to tighten and secure the strap to provide a firm grip on the load and minimize movement during transit. Strapping objects to vehicles involves a range of techniques and equipment tailored to different needs.

Straps are widely used in industries such as logistics, construction, and recreation, highlighting their versatility. In logistics, they play a crucial role in securing goods for transport, ensuring that cargo remains stable during shipment over long distances. In construction, straps are employed to secure heavy equipment, building materials, or scaffolding components, providing reliability in demanding environments. Recreational uses include securing outdoor gear, such as kayaks, bicycles, or camping equipment, to vehicles for safe travel. Across these applications, straps are valued for their durability, ability to adapt to different load sizes and shapes, and the assurance they provide in keeping items safely in place.

### SUMMARY

Apparatus and associated methods relate to a vehicle strapping system with two or more straps, wherein each strap includes two or more strap channels and two or more opposing securing mechanisms configured such that the first securing mechanism operably couples to a first wheel well and the second securing mechanism operably couples to a second wheel well with at least one strap positioned over the front of a vehicle and at least one strap positioned over the rear of a vehicle. In an illustrative example, a strapping system may include two or more straps. At least one strap, may for example, be positioned at the front of a vehicle. At least one opposing strap may, for example, be positioned at the rear of the vehicle. Each strap may, for example, include two or more securing mechanism. At least one securing mechanism may, for example, operably couple to a first wheel well. At least one opposing securing mechanism may, for example, operably couple to a second wheel well. Each strap may for example, include two or more strap channels. The strap channels may, for example, be configured to adjust the height of the straps such that a stowage area is above the wheel wells. Various embodiments may advantageously enable the strapping system to strap longitudinal material to vehicles.

Various embodiments may achieve one or more advantages. For example, some embodiments may advantageously enable the strapping system to strap material of various lengths to a vehicle. Some embodiments may, for example, enable the strapping system to strap material to vehicles of various sizes enabling a universal fit. Some embodiments may, for example, enhance safety by properly securing materials to a vehicle that may otherwise not fit within the vehicle.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary vehicle strapping system employed in an illustrative use-case scenario.

FIG. 2 depicts some embodiments of a front strap assembly and a rear strap assembly.

FIG. 3 depicts an exemplary schematic of strap assembly including strap channels.

FIG. 4 depicts an exemplary schematic of a tightening mechanism.

FIG. 5 depicts an exemplary schematic of a vehicle strapping system with a first strap in the front of a vehicle and a second strap in the rear of a vehicle.

FIG. 6 depicts an exemplary schematic of a securing mechanism.

FIG. 7A depicts an exemplary embodiment of a vehicle strapping system.

FIG. 7B depicts an exemplary embodiment of a vehicle strapping system.

FIG. 8 depicts an exemplary schematic of some embodiments of a vehicle strapping system.

Like reference symbols in the various drawings indicate like elements.

### DETAILED DESCRIPTION OF ILLUSTRATIVE EMBODIMENTS

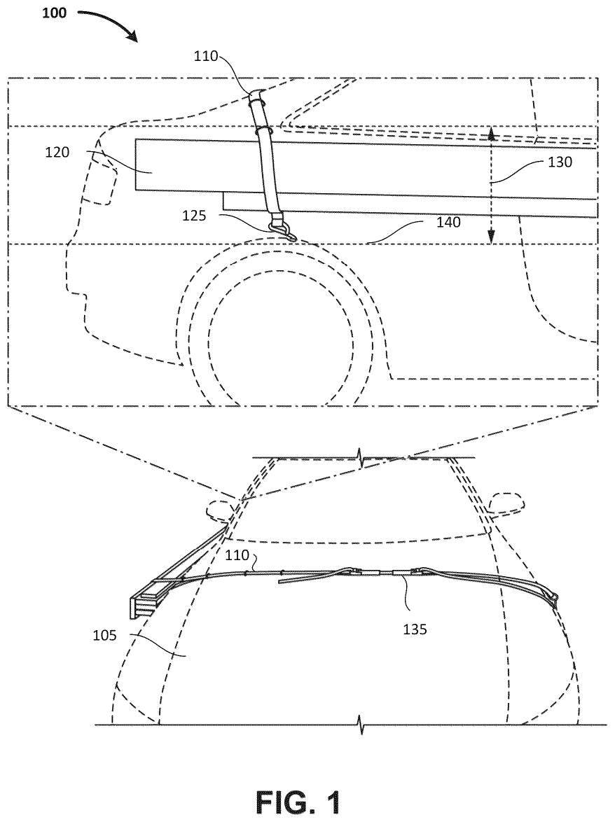

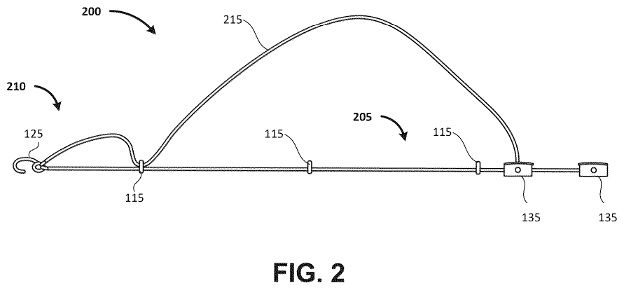

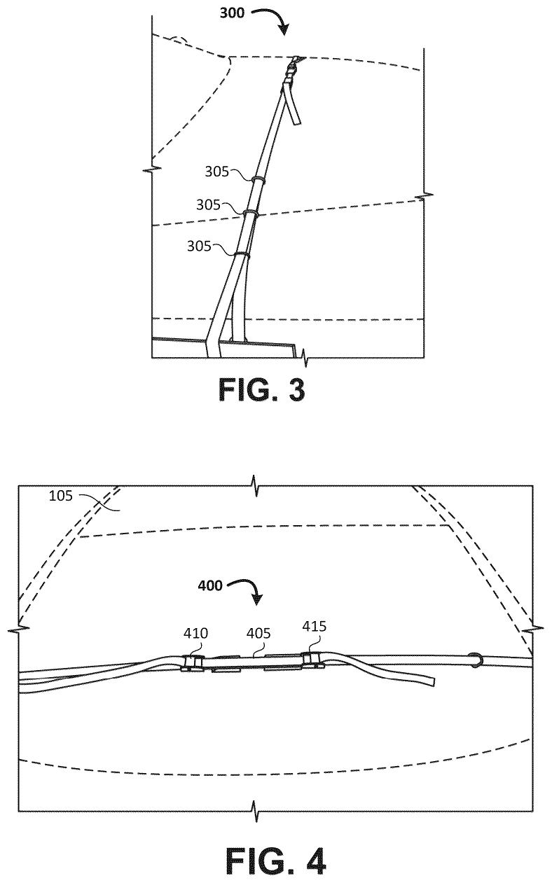

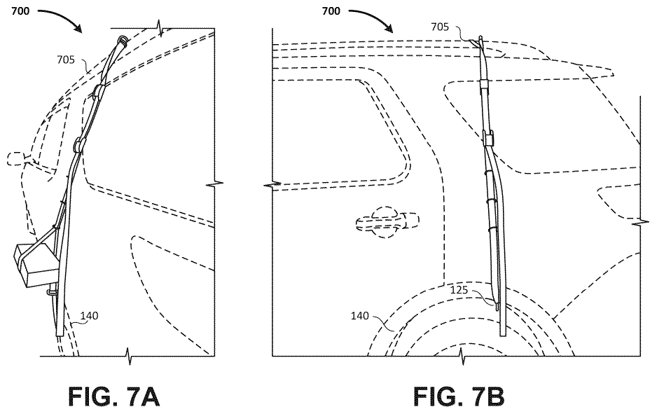

To aid understanding, this document is organized as follows. First, to help introduce discussion of various embodiments, a vehicle strapping system is introduced with reference to FIG. 1. Second, with reference to FIG. 2, is described an exemplary front and rear strap assembly. Third, that introduction leads into a description with reference to FIGS. 3-6 of some exemplary embodiments of elements of the system. FIG. 7A. 7B, and 8 discloses some exemplary embodiments of the vehicle strapping system.

FIG. 1 depicts an exemplary vehicle strapping system employed in an illustrative use-case scenario 100. In this scenario, the example includes a vehicle 105. For example, the vehicle 105 may be a car, as depicted. In this example, a vehicle strapping system may operably couple to the vehicle 105. The vehicle strapping system may, for example, include two or more strap assemblies 110. At least one strap assemblies 110 may, for example, be positioned over the front of the vehicle 105. At least one opposing strap assemblies 110 may, for example, be positioned over the rear of the vehicle 105. Each strap assemblies 110 may, for example, include two or more securing mechanisms 125. At least one securing mechanism 125 may, for example, operably couple to a first wheel well 140. At least one opposing securing mechanism 125 may, for example, operably couple to a second wheel well 140. Each strap assemblies 110 may, for example, include one or more strap channels 115. The strap channels 115 may, for example, be configured to adjust the height of the strap assemblies 110 such that a stowage area 130 is above the wheel wells 140. The stowage area 130 may, for example, be configured such that cargo 120 may be inserted within the strap assemblies 110. The strap assemblies 110 may, for example, include a tightening mechanism 135. The tightening mechanism 135 may advantageously enable the vehicle strapping system to tighten and secure the cargo 120 within the stowage area 130. The vehicle strapping system may advantageously enable the transport of various sized cargo 120. The vehicle strapping system may advantageously enable the transport of cargo 120 in various sized vehicles 105.

FIG. 2 depicts some embodiments of a front and a rear strap assembly 200. In some embodiments, a front strap assembly 200 and a rear strap assembly 200 each further include an adjustable support system 205. The adjustable support system 205, for example, may include a tightening mechanism 135 configured to secure the adjustable support system 205 across a vehicle 105. In some embodiments, the adjustable support system 205 includes first and second anchor ends 210. The first and second anchor ends 210 each may be coupled with a securing mechanism 125. The first and second securing mechanisms, for example, may be configured to couple the adjustable support system 205 to opposing wheel wells of a vehicle, wherein the first securing mechanism is coupled to the first anchor end, and the second securing mechanism is coupled to the second anchor end. Some embodiments include carry strap 215 anchored to at least one of the securing mechanisms at a carry end of the carry strap and operably coupled to the tightening mechanism. For example, the carry strap 215 may be attached to the anchor end 210. In some embodiments, the carry strap 215 is coupled with the adjustable support system 205 proximate to the carry end. Some embodiments of an adjustable support system 205 include a series of spaced strap channels fixed along the adjustable support system proximate to the securing mechanism at the carry end. The carry strap, for example, is routable through at least one of the strap channels to define a stowage area 130. Advantageously, the stowage areas 130 of the front and rear strap assemblies together form a continuous stowage area on the same lateral side of the vehicle.

FIG. 3 depicts an exemplary schematic of strap assembly 300 including strap channels 305. As depicted in FIG. 3, a strap of the strap assembly 300 may be fed through one or more strap channels 305, which is operable to tighten cargo 120. In some embodiments, one or more strap channels 305 have a spacing designed to facilitate different sizes of cargo. The strap channel 305 may, for example, comprise D rings, as depicted. In some embodiments, the strap channels 305 are at fixed spacing intervals. The strap channel 305 may, for example, be configured to adjust the height of the stowage area 130 by adjusting the distance between each strap channels 305. The strap channels 305 may, for example, advantageously enable the vehicle strapping system to carry cargo of various sizes. In some embodiments, the strap channels 305 are spaced six inches apart. Various embodiments include three strap channels 305. The strap channels 305 may, for example, advantageously enable the vehicle strapping system to carry cargo at various heights on the side of the vehicle 105.

In some embodiments, a series of spaced strap channels fixed along the adjustable support system proximate to the securing mechanism at the carry end, wherein the carry strap is routable through at least one of the strap channels to define a stowage area on one lateral side of the vehicle. Some embodiments include wherein the stowage areas of the front and rear strap assemblies together form a continuous stowage area on the same lateral side of the vehicle. In various embodiments, wherein a continuous stowage area is vertically spaced above a tire of the vehicle by at least a clearance distance. Advantageously, a user may secure cargo 120 to the vehicle 105 and tighten the load via the strap channels.

FIG. 4 depicts an exemplary tightening mechanism 400 having an interconnecting strap 405. The interconnecting strap 405 may include two ends each having a first tightening mechanism 410 and a second tightening mechanism 415. A tightening mechanism 410 may, for example, be a cam latch, as depicted. A tightening mechanism 410 may, for example, operably couple to the first end of an adjustable support system 205. A tightening mechanism 410 may, for example, operably couple to a second end of an adjustable support system 205. The tightening mechanism 410 may, for example, operably couple the first end of an interconnecting strap 405 to a second of an adjustable support system 205. The latch may, for example, advantageously enable a strap assembly 110 to tighten and loosen itself to a vehicle 105.

In some embodiments, the adjustable support system 205 comprises first and second support straps respectively coupled to the first and second anchor ends, and a interconnecting strap 405 extending between the support straps, the interconnecting strap carrying first and second tightening mechanisms at opposite ends; and wherein the carry strap is anchored at the carry end of the carry strap to one of the securing mechanisms and operably coupled to one of the first and second tightening mechanisms.

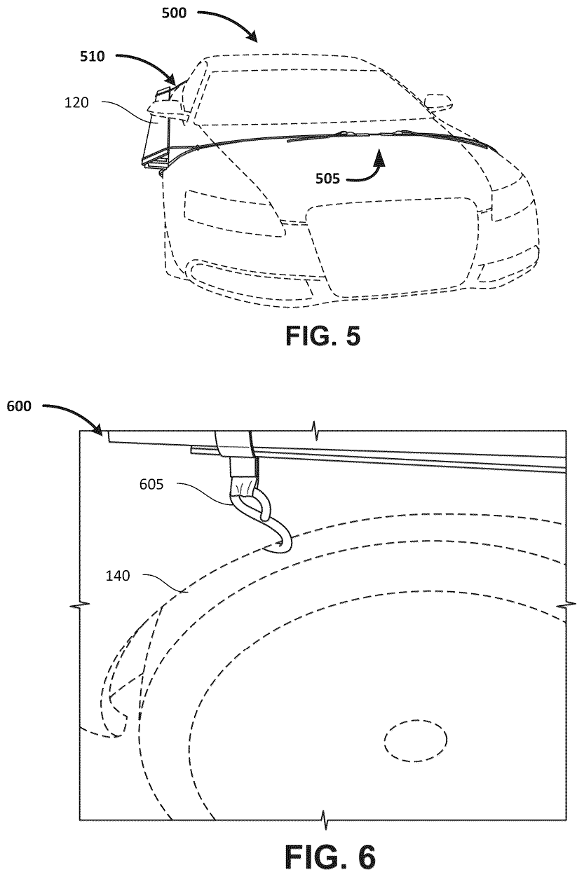

FIG. 5 depicts an exemplary schematic of a vehicle strapping system with a first strap in the front of a vehicle and a second strap in the rear of a vehicle 500. The front strap assembly 505 may, for example, include a front portion of cargo 120. The rear strap assembly 510 may, for example include a rear portion of cargo 120. The vehicle strapping system with a first strap in the front of a vehicle and a second strap in the rear of a vehicle may, for example, advantageously enable the vehicle strapping system to carry longitudinal cargo. In some embodiments, the vehicle strapping system is capable of supporting a static load of at least 300 pounds within the continuous stowage area.

FIG. 6 depicts an exemplary schematic of a securing mechanism 600. A securement device 605 may, for example, be a hook, as depicted. The securement device 605 may, for example, operably couple to a wheel well 140. In some embodiments, the securement device 605 includes a hook with a width of about 42 centimeters in width. A 42-centimeter width, for example, may provide a universal fit for wheel wells 140. In some embodiments, the securement device 506 may include a magnetic attachment mechanism operably coupled to the wheel well or frame of the vehicle 105.

FIGS. 7A and 7B depicts an exemplary schematic of a second embodiment of a vehicle strapping system 700. The second embodiment of the vehicle strapping system may, for example, include a first securing mechanism 125. The first securing mechanism 125 may, for example, operably couple to a wheel well 140. The second embodiment of the vehicle strapping system may, for example, include a second securing mechanism 125. The second securement mechanism 125 may, for example operably couple to a roof rail 705. The second embodiment of the vehicle strapping system may, for example, advantageously enable the carrying of smaller cargo.

In some embodiments, the first and second securing mechanisms configured to couple the adjustable support system to either to a roof rail member and to a wheel well of the vehicle on a same lateral side, wherein the first securing mechanism is coupled to the first anchor end, and the second securing mechanism is coupled to the second anchor end.

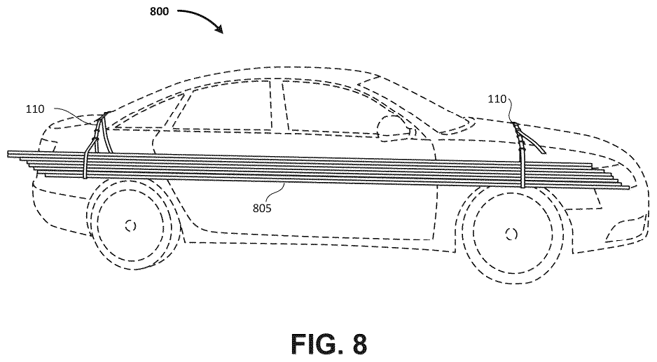

FIG. 8 depicts an exemplary schematic of a second embodiment of a vehicle strapping system 800. The vehicle strapping system 800 may, for example, include straps made from webbing. The straps made from webbing may, for example, advantageously enable the vehicle strapping system to carry heavy weight cargo. The vehicle strapping system may, for example carry lumber 805, as depicted.

In some implementations, the vehicle strapping system may, for example, include two separate straps and that make up the at least one strap assemblies 110 positioned in the rear of the vehicle 105 and the at least one strap assemblies 110 positioned in the front of the vehicle 105. The two separate straps and may, for example, be configured within strap channel 115. The strap channels 115 may, for example, advantageously enable the vehicle strapping system to adjust the height of the two separate straps and such that a stowage area 130 is above the wheel wells 140. The stowage area 130 may, for example, be configured to hold cargo 120. A first strap includes two or more securing mechanisms 125. At least one securing mechanism 125 may operably couple to a first wheel well 140. At least one opposing securing mechanism 125 may operably couple to a second wheel well 140. A second strap includes a tightening mechanism 135. The tightening mechanism 135 may advantageously enable the vehicle strapping system to tighten and secure the cargo 120 within the stowage area 130. In some embodiments, the continuous stowage area is vertically spaced above a tire of the vehicle by at least a clearance distance.

In some embodiments, the vehicle strapping system includes a protective pad. The protective pad, for example, may be a nonmarring pad operable to protect the vehicle's surface between the strap assembly 110 or the cargo 120 and the vehicle 105. In some embodiments, the protective pad includes one or more fastening mechanisms. The fastening mechanism, for example, may secure the protective pad to the strap assemblies 110 or cargo 120. In some embodiments, the securing mechanism at the carry end includes a nonmarring pad or sleeve. In various embodiments the protective pad may include neoprene. Various embodiments include various pad shapes including, but not limited to, square, rectangular, and circular.

In some embodiments, the vehicle strapping system includes the hook and loop attachment strip for the tightening mechanism. Some embodiments include the protective pad include two hook and loop attachment mechanisms for securing the pad against the cargo 120.

In some embodiments, the tightening mechanism pulls the carry strap tight.

In some embodiments, the maximum length of the strap assembly 110 is approximately 32 inches.

In some implementations, the vehicle strapping system may, for example, utilize a rope-based design tailored for lighter loads. The vehicle strapping system may, for example, provide a cost-effective solution for transporting materials weighing less than 300 lbs. The vehicle strapping system may, for example, include adjustable D-rings that offer flexibility in securing loads at various heights. The vehicle strapping system may, for example, keep the loaded material level and safe from contact with the wheel wells. The vehicle strapping system may, for example, be used for a lightweight solution for casual and/or light-duty applications. The vehicle strapping system may, for example, ensure stability and safety for smaller and lighter items during transportation.

In some implementations, the vehicle strapping system may, for example, feature webbing straps designed to accommodate heavier loads. The vehicle strapping system may, for example, handle weights of up to 300 lbs with cam buckles rated to secure loads exceeding 1000 lbs. The vehicle strapping system may, for example, include D-rings that allow users to adjust the strap heights for better load stability. The vehicle strapping system may, for example, provide a durable and robust solution for demanding applications involving heavy materials. The vehicle strapping system may, for example, be suitable for transporting large and bulky items securely over long distances. The vehicle strapping system may, for example, ensure that materials remain stable and well-positioned throughout transit.

In some implementations, the vehicle strapping system may, for example, be used to securely transport long pieces of wood, such as 2×4s, 4×4s, or decking materials. The vehicle strapping system may, for example, provide a reliable method for transporting heavy and/or lengthy wood materials safely. The vehicle strapping system may, for example, allow users to adjust the strap positions to accommodate varying lengths of wood. The vehicle strapping system may, for example, keep materials level and secure during transportation. The vehicle strapping system may, for example, make it easier to transport construction supplies for both professional and personal projects.

In some implementations, the vehicle strapping system may, for example, be used to carry pipes or conduits. The vehicle strapping system may, for example, securely hold cylindrical materials in place during transit. The vehicle strapping system may, for example, include D-rings to adjust the height and stability of the load. The vehicle strapping system may, for example, ensure that long and unwieldy materials are transported safely and efficiently. The vehicle strapping system may, for example, prevent items from shifting or becoming unstable while in motion. The vehicle strapping system may, for example, offer a dependable solution for tradespeople moving essential tools and materials.

In some implementations, the vehicle strapping system may, for example, be used to carry outdoor gear, such as fishing rods, kayaks, and/or kayak paddles. The vehicle strapping system may, for example, provide a secure and adjustable method for transporting recreational equipment. The vehicle strapping system may, for example, accommodate items of various sizes and shapes with ease. The vehicle strapping system may, for example, keep gear level and protected from damage during travel.

In some implementations, the vehicle strapping system may, for example, facilitate the transportation of delicate trim, crown molding, and/or fragile materials. The vehicle strapping system may, for example, ensure that sensitive items are securely held in place without damage. The vehicle strapping system may, for example, allow for adjustable configurations to protect materials of different dimensions. The vehicle strapping system may, for example, be a valuable tool for home improvement professionals and hobbyists. The vehicle strapping system may, for example, provide the stability needed to carry fragile items safely over long distances. The vehicle strapping system may, for example, make it easier to complete projects by ensuring safe and reliable material transport.

In some implementations, the vehicle strapping system may, for example, be useful for transporting lightweight fence posts, small light poles, and/or similar materials. The vehicle strapping system may, for example, provide a secure method to hold elongated materials in place. The vehicle strapping system may, for example, be adjustable to ensure materials remain level during transport. The vehicle strapping system may, for example, be used to transport items for home improvement or landscaping projects.

Although various embodiments have been described with reference to the figures, other embodiments are possible.

Although an exemplary system has been described with reference to FIG. 1-8 and, other implementations may be deployed in other industrial, scientific, medical, commercial, and/or residential applications. Industrially it can ensure safe and efficient transportation of raw materials. In scientific applications, this system can securely move delicate equipment or structural components. Medical logistics can benefit by transporting large medical apparatus or modular hospital structures. Commercially, retailers can use it to transport goods to distribution centers or direct to consumers. In residential settings, homeowners can rely on it for secure transportation of different materials of various sizes.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A vehicle strapping system, comprising:
a front strap assembly and a rear strap assembly, each further comprising:
an adjustable support system including a tightening mechanism and first and second anchor ends;
first and second securing mechanisms configured to couple the adjustable support system to opposing wheel wells of a vehicle, wherein the first securing mechanism is coupled to the first anchor end, and the second securing mechanism is coupled to the second anchor end;
a carry strap anchored to at least one of the securing mechanisms at a carry end of the carry strap and operably coupled to the tightening mechanism; and
a series of spaced strap channels fixed along the adjustable support system proximate to the securing mechanism at the carry end, wherein the carry strap is routable through at least one of the strap channels to define a stowage area;
wherein the stowage areas of the front and rear strap assemblies together form a continuous stowage area on a same lateral side of the vehicle.

2. The vehicle strapping system of claim 1, wherein the adjustable support system comprises first and second support straps respectively coupled to the first and second anchor ends, and a interconnecting strap extending between the support straps, the interconnecting strap carrying first and second tightening mechanisms at opposite ends; and wherein the carry strap is anchored at the carry end of the carry strap to one of the securing mechanisms and operably coupled to one of the first and second tightening mechanisms.

3. The vehicle strapping system of claim 1, wherein the strap channels comprise D-rings.

4. The vehicle strapping system of claim 1, wherein the strap channels are at fixed spacing intervals.

5. The vehicle strapping system of claim 1, wherein the continuous stowage area is vertically spaced above a tire of the vehicle by at least a clearance distance.

6. The vehicle strapping system of claim 1, wherein the vehicle strapping system is capable of supporting a static load of at least 300 pounds within the continuous stowage area.

7. The vehicle strapping system of claim 1, wherein the securing mechanism at the carry end includes a nonmarring pad or sleeve.

8. A strap assembly, comprising:
an adjustable support system including a tightening mechanism and first and second anchor ends;
first and second securing mechanisms configured to couple the adjustable support system to opposing wheel wells of a vehicle, wherein the first securing mechanism is coupled to the first anchor end and the second securing mechanism is coupled to the second anchor end;
a carry strap anchored to at least one of the securing mechanisms at a carry end of the carry strap and operably coupled to the tightening mechanism; and
a series of spaced strap channels fixed along the adjustable support system proximate to the securing mechanism at the carry end, wherein the carry strap is routable through at least one of the strap channels to define a stowage area on one lateral side of the vehicle.

9. The strap assembly of claim 8, wherein the adjustable support system comprises first and second support straps respectively coupled to the first and second anchor ends, and an interconnecting strap extending between the support straps, the interconnecting strap carrying first and second tightening mechanisms at opposite ends; and wherein the carry strap is anchored at the carry end of the carry strap to one of the securing mechanisms and operably coupled to one of the first and second tightening mechanisms.

10. The strap assembly of claim 8, wherein the strap channels comprise D-rings.

11. The strap assembly of claim 8, wherein the tightening mechanisms comprise cam latches.

12. The strap assembly of claim 8, wherein the strap channels are at fixed spacing intervals.

13. The strap assembly of claim 8, wherein the securing mechanism at the carry end includes a nonmarring pad or sleeve.

14. A vehicle strapping system having a roof rail, comprising:
a front strap assembly and a rear strap assembly, each further comprising:
an adjustable support system including a tightening mechanism and first and second anchor ends;
first and second securing mechanisms configured to couple the adjustable support system to either to a roof rail member and to a wheel well of the vehicle on a same lateral side, wherein the first securing mechanism is coupled to the first anchor end, and the second securing mechanism is coupled to the second anchor end;
a carry strap anchored to at least one of the securing mechanisms at a carry end of the carry strap and operably coupled to the tightening mechanism; and
a series of spaced strap channels fixed along the adjustable support system proximate to the securing mechanism at the carry end, wherein the carry strap is routable through at least one of the strap channels to define a stowage area;
wherein the stowage areas of the front and rear strap assemblies together form a continuous stowage area on the same lateral side of the vehicle.

15. The vehicle strapping system having a roof rail of claim 14, wherein the adjustable support system comprises first and second support straps respectively coupled to the first and second anchor ends, and a interconnecting strap extending between the support straps, the interconnecting strap carrying first and second tightening mechanisms at opposite ends; and wherein the carry strap is anchored at the carry end of the carry strap to one of the securing mechanisms and operably coupled to one of the first and second tightening mechanisms.

16. The vehicle strapping system having a roof rail of claim 14, wherein the strap channels comprise D-rings.

17. The vehicle strapping system having a roof rail of claim 14, wherein the strap channels are at fixed spacing intervals.

18. The vehicle strapping system having a roof rail of claim 14, wherein the continuous stowage area is vertically spaced above a tire of the vehicle by at least a clearance distance.

19. The vehicle strapping system having a roof rail of claim 14, wherein the system is capable of supporting a static load of at least 300 pounds within the continuous stowage area.

20. The vehicle strapping system having a roof rail of claim 14, wherein the securing mechanism at the carry end includes a nonmarring pad or sleeve.
